(19) United States
(12) Patent Application Publication
(10) Pub. No.: US 2010/0091190 A1
(43) Pub. Date: Apr. 15, 2010

(54) DISPLAY CONTROL DEVICE AND DISPLAY DEVICE

(75) Inventor: Atsushi Mino, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi, Hyogo (JP)

(21) Appl. No.: 12/521,845

(22) PCT Filed: Jan. 16, 2008
(86) PCT No.: PCT/JP2008/050414

§ 371 Date: Jun. 30, 2009

(30) Foreign Application Priority Data
Jan. 16, 2007 (JP) 2007-006599

(51) Int. Cl. H04N 5/445

(52) U.S. Cl. 348/564; 348/E05.099

(57) ABSTRACT

Provided is a display control device and a display device that are capable of preventing degradation of image quality caused by video dot crawling when the display device provides for different displays corresponding to a plurality of viewing directions and is set to display the same video signals when viewed from the viewing directions. A display control device 4 includes a video signal generating portion 42 for generating video signals corresponding to different viewing directions from a plurality of source signals so that the display control device 4 outputs the video signals to a display portion 11 capable of displaying different videos on a common screen in the different viewing directions. The video signal generating portion 42 includes a delay processing portion 424 for, when the source signals for the videos displayed in the different viewing directions are the same, delaying a scan line of one video signal by a predetermined line number relative to a scan line of another video signal.

This application is the U.S. national phase of international application PCT/JP2008/050414, filed on Jan. 16, 2008, which designated the U.S. and claims priority to JP Application No. 2007-006599, filed on Jan. 16, 2007. The entire contents of these applications are incorporated herein by reference.

### TECHNICAL FIELD

The present invention relates to a display control device that includes a video signal generating portion for generating video signals from a plurality of source signals corresponding to different viewing directions and that outputs the video signals to a display portion capable of displaying different videos on a common screen in the different viewing directions. The present invention also relates to a display device that includes the display control device and the display portion.

### BACKGROUND ART

Color television receivers may in some cases encounter degradation of image quality caused by a dot crawl, which is such a phenomenon that during what is called a Y/C separation for separating a composite video signal, which is a received video signal, into a luminance signal and a chrominance signal, a component of a chrominance sub-carrier wave, which is the carrier of the chrominance signal, leaks to a component of the luminance signal at a boundary of change in the luminance signal.

In order to prevent the degradation of image quality, many techniques have been proposed regarding delaying the input source signal for a predetermined horizontal scanning period.

For example, patent document 1 describes a luminance signal/chrominance signal separating circuit configured to include: a bandwidth limiting filter for allowing only a source signal around the frequency of the chrominance sub-carrier wave to pass through the filter; a 1-line delaying circuit for delaying the output of the bandwidth limiting filter for 1 horizontal scanning period; an adder for calculating the sum of the output of the 1-line delaying circuit and the output of the bandwidth limiting filter; an inverter for inverting the output of the adder; a median value selection circuit for selecting a signal with a median value among the output of the inverter, the output of the 1-line delaying circuit, and the output of the bandwidth limiting filter; and a subtracter for subtracting the output of the median value selection circuit from the output of the bandwidth limiting filter. This configuration eliminates dot crawling in the following manner.

When no change occurs in the input luminance signal, the median value selection circuit outputs the output of the inverter as it is (i.e., the signal delayed for 1 horizontal scanning period at the 1-line delaying circuit), while when a change occurs in the luminance signal, the median value selection circuit outputs the signal before being subject to the 1 horizontal scanning period delay. Thus, when a change occurs in the luminance signal, the output of the subtracter is cancelled resulting in zero, and thereby dot crawling is eliminated.

However, in the NTSC standard, the phase of the chrominance sub-carrier wave shifts by 180 degrees on a 1 horizontal, scanning period basis, and therefore when a dot crawl occurs while a video signal is received according to the NTSC standard, the leak chrominance sub-carrier wave in the luminance signal averages out between adjacent lines and becomes less recognizable even when the above-described technique to prevent degradation of image quality is not used. That is, referring to FIG. 1, even though dot crawls occur near the boundaries of pixel groups “m” to “m+3” of four kinds of luminance, a pixel of a degrees for the chrominance sub-carrier wave phase and a pixel of α+180 degrees for the chrominance sub-carrier wave phase are arranged so that each is adjacent to the other on the top, bottom, right, and left sides. Thus, the leak component of the chrominance sub-carrier wave in the luminance signal averages out and becomes less recognizable on the displayed image.

[Patent document 1] Japanese Unexamined Patent Publication No. 6-22332.

### DISCLOSURE OF THE INVENTION

### Problems that the Invention is to Solve

Incidentally, in recent years, in many vehicle navigation systems and the like there have been used multi-view displays, in which a single display is configured to simultaneously display a video from a source signal and another video from a source signal different from the foregoing source signal without changing the size of the display area of the display in such a manner that one of the videos of different source signals can be seen when the display is viewed from one viewing direction and the other video can be seen when the display is viewed from another viewing direction.

For example, in the case of a dual view display, among the multi-view displays, that is configured to show videos from different source signals in left and right viewing directions, two pixel groups made up of a first pixel group corresponding to the left direction and a second pixel group corresponding to the right direction are alternately arranged on the basis of a predetermined number of data lines.

Even when such a multi-view display is used, the multi-view display may not necessarily be set to display videos from different source signals when viewed from different directions; in some cases, the multi-view display may be set to display a video from the same source signals, i.e., display the same video, even when viewed from the different directions.

When a dot crawl occurs in such a situation, the phases of adjacent source signals become identical to one another at the boundary of pixel groups corresponding to two viewing directions.

That is, as described above, when a dot crawl occurs in a usual display, the leak chrominance sub-carrier wave in the luminance signal averages out between adjacent upper and lower lines and right and left lines to become less recognizable. In the multi-view display, referring to FIG. 2, the phase shift between the upper and lower adjacent lines is 180 degrees as in the case of FIG. 1, and therefore the leak chrominance sub-carrier wave in the luminance signal averages out and becomes less recognizable. Between the right and left adjacent lines, however, the phases at the pixels at the boundary of the right viewing direction pixel group and the left viewing direction pixel group become identical to each other. This emphasizes the leak chrominance sub-carrier wave in the luminance signal, thereby causing degradation of image quality.

In view of the foregoing problems, it is an object of the present invention to provide a display control device and a display device that are capable of preventing degradation of image quality caused by video dot crawling when the display device provides for different displays corresponding to a plurality of viewing directions and is set to display the same video signals when viewed from the viewing directions.

### Means of Solving the Problems

In order to accomplish the above object, a feature configuration of a display control device according to the present invention is as follows. The display control device includes a video signal generating portion for generating video signals from a plurality of source signals to correspond to different viewing directions, and outputs the video signals to a display portion capable of displaying different videos on a common screen in the different viewing directions. The video signal generating portion includes a delay processing portion for, when the source signals for the videos displayed in the different viewing directions are the same, delaying a scan line of one video signal by a predetermined line number relative to a scan line of another video signal.

With the above configuration, the delay processing portion delays the scan line of one of the video signals relative to the scan line of another video signal by such a line number that the phases of the leak chrominance sub-carrier waves of the video signals are shifted from one another by 180 degrees between adjacent lines, and thereby the leak chrominance sub-carrier wave in the luminance signal averages out between the adjacent lines and becomes less recognizable. This prevents degradation of image quality.

### Effects of the Invention

As has been described hereinbefore, the present invention has made it possible to a provide a display control device and a display device that are capable of preventing degradation of image quality caused by video dot crawling when the display device provides for different displays corresponding to a plurality of viewing directions and is set to display the same video signals when viewed from the viewing directions.

### BRIEF DESCRIPTION OF THE DRAWINGS

FIG. 1 is a diagram for describing averaging of a chrominance sub-carrier wave between adjacent pixels.

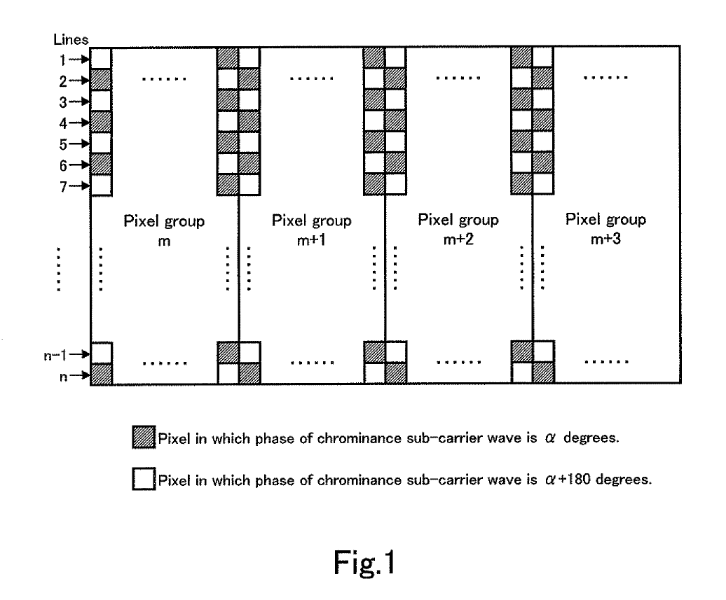

FIG. 2 is a diagram for describing emphasis of a chrominance sub-carrier wave between adjacent pixels.

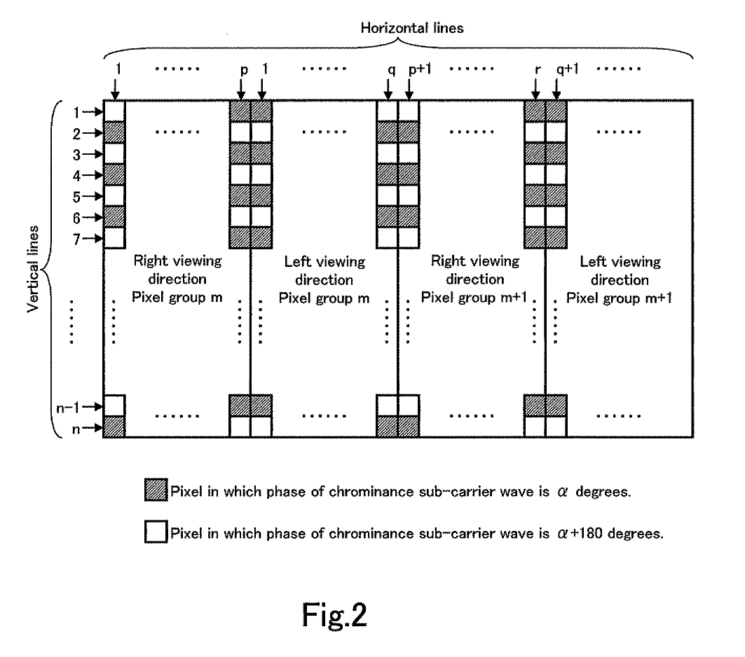

FIG. 3 is a configuration block diagram of a display device according to the present invention.

FIG. 4 is a diagram illustrating a liquid crystal panel.

FIG. 5 is a diagram illustrating a driving circuit of the liquid crystal panel.

FIG. 6 is a configuration block diagram of a display control device according to the present invention.

FIG. 7 is a flowchart for describing the operation of the display device of the present invention.

FIG. 8A shows a pixel display in the case where a scan line is not delayed; and FIG. 8B shows a pixel display in the case where a scan line is delayed by a predetermined field number.

FIG. 9A shows a pixel display in the case where a scan line is not delayed; and FIG. 9B shows a pixel display in the case where a scan line is delayed by a predetermined frame number.

### DESCRIPTION OF REFERENCE NUMERAL

1 Display device

11: Display portion

4: Display control portion

42: Video signal generating portion

421: Source signal selecting portion

422: Decoding portion

423: RGB signal generating portion

424: Delay processing portion

425: Synthesis editing portion

### BEST MODE FOR CARRYING OUT THE INVENTION

The following describes an embodiment where the display control device according to the present invention is applied to an on-board display device capable of displaying different videos or the same videos on a common screen in different viewing directions.

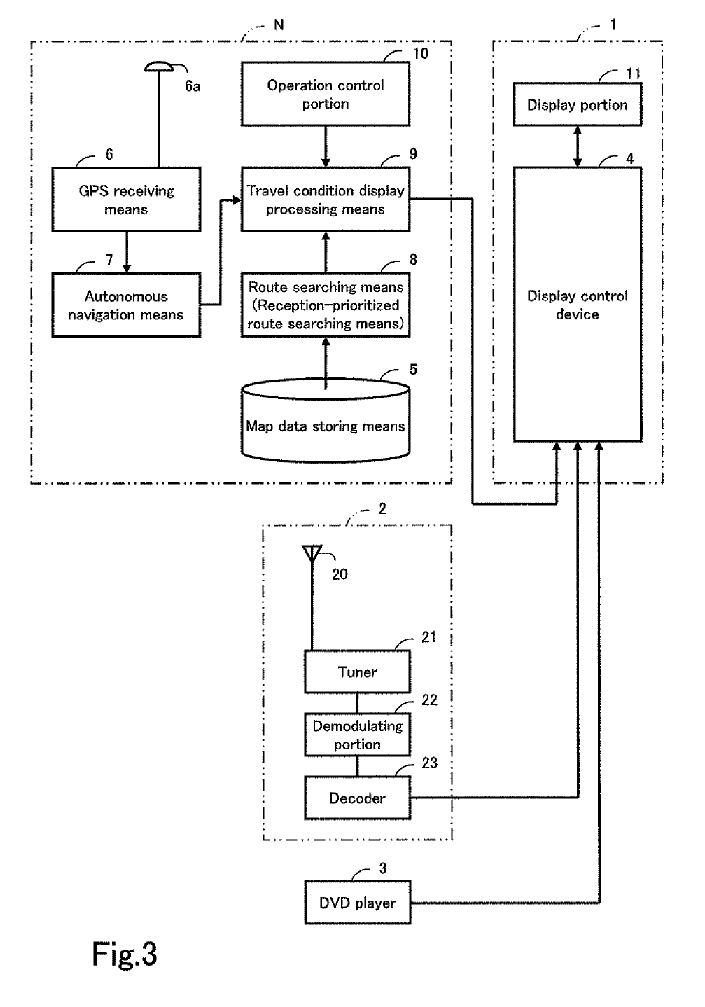

Referring to FIG. 3, a vehicle mounts therein a navigation device N for guiding the vehicle to a destination, a radio wave receiving device 2 for receiving terrestrial digital broadcast, a DVD player 3, and a display device 1 for displaying images of video signals based on source signals received from the foregoing. The display device 1 is configured to include a touch panel-type display portion 11 and a display control device 4 for controlling display on the display portion 11.

The navigation device N is configured to include a map data storing means 5 storing road map data, a GPS receiving means 6 for recognizing location information of the vehicle of interest, a GPS antenna 6a, an autonomous navigation means 7 for managing the travel conditions of the vehicle of interest, a route searching means 8 for searching for a route to a destination specified on the basis of the map data, a travel condition display processing means 9 for displaying the travel location of the vehicle of interest on a map, and an operation control portion 10 for setting various operation modes and operation conditions. The navigation device N is also configured to include a single or a plurality of CPUs, a ROM storing an operation program for the CPU, and a RAM used as a working area in order to control the blocks. Thus, the navigation device N has a navigation function to guide the vehicle of interest to a specified point.

The radio wave receiving device 2 is configured as a digital television receiver that includes a receiving antenna 20, a tuner 21 for selecting a transmission channel (frequency band) received through the receiving antenna 20, an OFDM demodulating portion 22 for carrying out error correction processing of a digital signal retrieved from the selected received signal and for outputting TS (transport stream) packets, and a decoder 23 for decoding an audio signal from a video-audio packet among the TS packets and outputting the audio signal to a speaker SP (not shown) and for decoding a video signal and outputting it to the display control device 4.

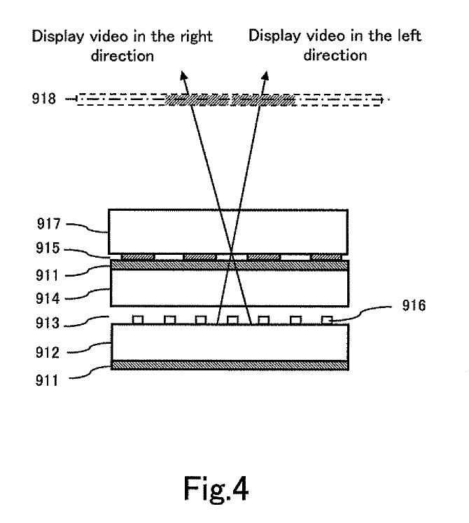

The display portion 11 is configured to be able to display different videos or the same videos on a common screen in different viewing directions, and to integrally form: a liquid crystal panel including a TFT substrate 912 having formed thereon a TFT array 916 and an opposing substrate 914 arranged in an opposing manner relative to the TFT substrate 912, a liquid crystal layer 913 sandwiched between the pair of substrates, and two polarizing plates 911 between which the pair of substrates are arranged; and a parallax barrier substrate 917 having formed thereon a parallax barrier layer 915 having formed thereon microlenses and light shielding slits, as shown in FIG. 4.

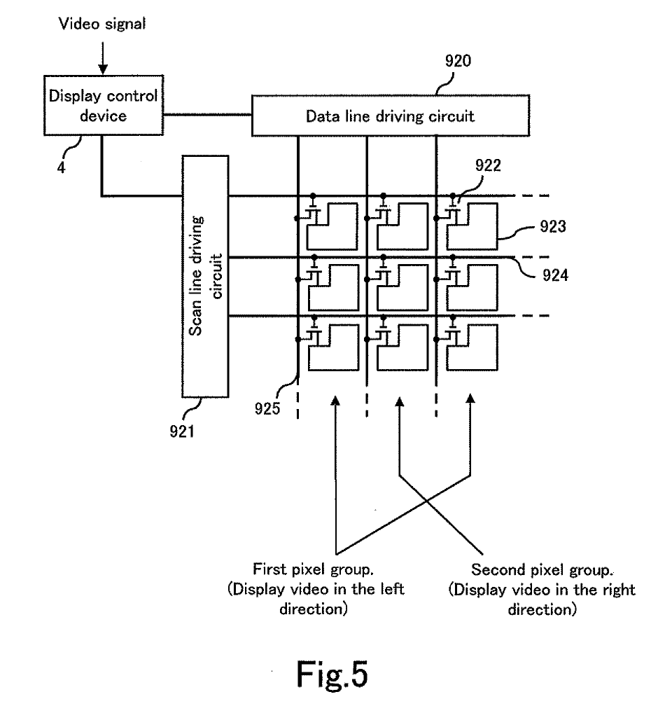

Referring to FIG. 5, the TFT array 916 has formed thereon a plurality of pixels with each of the areas surrounded by a data line 925 and a scan line 924 acting as one unit. Each of the pixels has formed therein a pixel electrode 923 for applying voltage to the liquid crystal layer 913 and a TFT element 922 for carrying out switching control of the pixel electrode 923. A scan line driving circuit 921 selectively scans the TFT elements 922, and a data line driving circuit 920 controls the voltage application to the pixel electrode 923. The display control device 4 controls driving timing of the scan line driving circuit 921 and the data line driving circuit 920.

The plurality of pixels are composed of two pixel groups, namely, a first pixel group corresponding to a first viewing direction and a second pixel group corresponding to a second viewing direction, which have respective pixels arranged alternately (on every two data lines so that the groups are classified into odd-numbered rows and even-numbered rows). Thus, each group is driven independently on the basis of a video signal of different source. Referring to FIG. 4, beams of light passing through the two pixel groups are guided in different directions by the parallax barrier layer 915, or beams of light of particular directions are shielded by the parallax barrier layer 915, so that different videos can be displayed in different directions only in the spatial vicinity of a display screen 918. It should be noted that the two pixel groups are not limited to the alternate arrangement but may be distributed over the screen in any other manner.

The display device 1 is mounted on a front panel in a middle portion of the driver's seat and the passenger seat and configured to be able to display a video viewed from the driver's seat side, which is the first viewing direction, in a different manner from a video viewed from the passenger seat side, which is the second viewing direction. For example, such a configuration is employed that at the passenger seat side, video information of a television program received at the radio wave receiving device 2 is seen, while at the driver's seat side, a route guiding video from the navigation device N is seen.

The display control device 4 is configured to include a CPU operative on the basis of a predetermined control program, a RAM for storing control data and the like, a ROM storing a control program, and necessary peripheral circuits.

The display control device 4 is configured to implement, with a control program executed by the CPU, a function implemented by functional blocks detailed below; specifically, the function to generate video signals from a plurality of source signals corresponding to different viewing directions and output the video signals to the display portion 11.

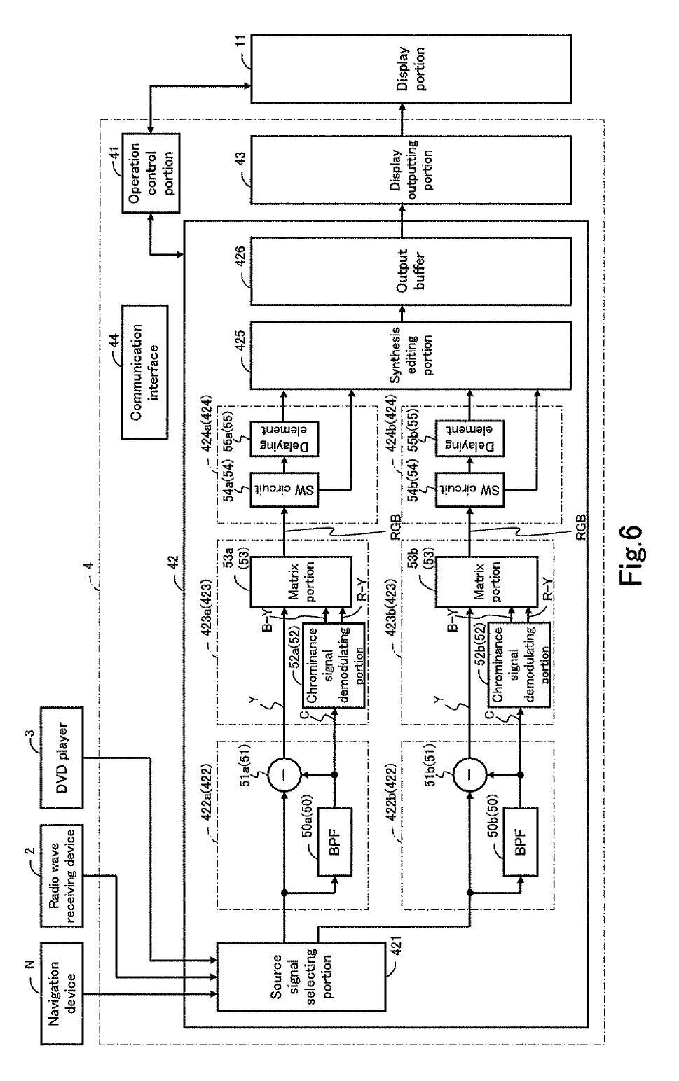

The functional blocks will be detailed below. Referring to FIG. 6, the functional blocks are configured to include an operation control portion 41 for setting and operating display modes and the like, a video signal generating portion 42 for editing the source signals into video signals corresponding to the display portion 11, a display outputting portion 43 for displaying the edited video signals on the screen of the display portion 11, and a CAN-dedicated communication interface 44 for exchanging necessary control data and the like with an electronic engine control portion (not shown), which carries out driving control of the vehicle engine, the navigation device N, and the like.

The navigation device N, the radio wave receiving device 2, the DVD player 3, and the like are also provided with communication interfaces corresponding to the communication interface 44, although not shown in the figure. It also should be noted that the communication interface 44 is not limited to CAN; any known communication interface may be conveniently used.

The operation control portion 41 is configured to display on the screen of the display portion 11 operation keys for the navigation device N, the radio wave receiving device 2, and the DVD player 3, from which source signals are input to the display device 1, and to display unique operation keys for the display portion 11 on the screen, so that the operation control portion 41 acts as a user interface for transmitting, to the appliances through the communication interface 44, predetermined behaviors responsive to keys operated through a touch panel.

The video signal generating portion 42 is configured to include: a source signal selecting portion 421 acting as a switching circuit for selecting source signals from among the source signals input from the navigation device N, the radio wave receiving device 2, the DVD player 3, and the like on the basis of display conditions operated at the operation control portion 41; decoding portions 422 (422a, 422b) for carrying out the processing of separating each of the source signals, which are dual source signals selected at the source signal selecting portion 421, into a luminance signal and a chrominance signal; RGB signal generating portions 423 (423a, 423b) for generating RGB signals as video signals on the basis of the luminance signal and chrominance signal separated at each decoding portion 422; delay processing portions 424 (424a, 424b) for delaying a scan line of one video signal of the dual video signals generated at the RGB signal generating portions 423 by a predetermined line number relative to a scan line of the other video signal; a synthesis editing portion 425 for carrying out synthesis editing of the dual video signals into a single video signal; and an output buffer 426 for buffering the video signal synthesized by the synthesis editing.

The decoding portions 422 are configured to include: band pass filters 50 (50a, 50b) for allowing only source signals, among the source signals input from the source signal selecting portion 421, that are near the frequency of the chrominance sub-carrier wave to pass through the band pass filters 50, and for outputting chrominance signals C; and subtracters 51 (51a, 51b) for outputting luminance signals Y resulting from subtracting the output of the band pass filters 50 from the source signals.

The RGB signal generating portions 423 are configured to include: chrominance signal demodulating portions 52 (52a, 52b) for extracting two kinds of color difference signals (B−Y) and (R−Y)on the basis of the chrominance signals C separated at the decoding portions 422; and matrix portions 53 (53a, 53b) for generating RGB signals on the basis of the luminance signals Y separated at the decoding portions 422 and of the color difference signals (B−Y) and (R−Y).

The chrominance signal demodulating portions 52 are configured to extract the color difference signals R-Y and B-Y by decomposing the chrominance signal C, which is represented by [Formula 1], into vector components. In this regard, any known color difference signal demodulating circuit may be used.

C=(R−Y)×cos (2πf_{sc}t)+(B−Y)×sin (2πf_{sc}t) [Formula 1]

In the formula, f_{sc} denotes the frequency of the chrominance sub-carrier wave; for example, f_{sc}=3.579545 MHz in the case of the NTSC standard.

The matrix portions 53 are each configured to derive an RGB signal (video signal) composed of three signals, namely, R, G, and B, by applying the luminance signal Y and the color difference signals (R−Y) and (B−Y)to [Formula 2].

Y=0.299R+0.587G+0.114B (R−Y)=0.701R−0.587G−0.114B (B−Y)=−0.299R−0.587G+0.886B [Formula 2]

The delay processing portions 424 are configured to, when the source signals for the videos displayed in the viewing directions are the same, delay a scan line of one video signal by a predetermined line number relative to a scan line of another video signal, and include: switching circuits 54 (54a, 54b) for switching between outputting destinations for the input video signals; and delaying elements 55 (55a, 55b) each composed of a memory or the like for storing the input video signals for a predetermined period of time.

The switching circuits 54 are each configured to switch between outputting the video signal input from the matrix portions 53 to the synthesis editing portion 425 through the delaying elements 55 and outputting the video signal directly to the synthesis editing portion 425, without mediation of the delaying elements 55.

Specifically, for the source signal through the decoding portion 422a and the source signal through the decoding portion 422b, the delay processing portions 424 output one of the source signals to the synthesis editing portion 425 through the delaying element 55a or 55b), while outputting the other source signal directly to the synthesis editing portion 425, without mediation of the delaying element 55b (or 55a), thereby delaying the scan line of the one (or the other) video signal by a predetermined line number relative to the scan line of the other (or the one) video signal.

More specifically, the delay processing portions 424 are configured to delay the scan line by a line number determined on the basis of the phase, which is controlled on a scan line basis, of the chrominance sub-carrier wave constituting the source signal. For example, in the case where the input source signal is a signal that is based on the NTSC standard, the phase of the chrominance sub-carrier wave is shifted by 180 degrees on a scan line basis; therefore, the predetermined line number is determined at “1” and the scan line is delayed by “1” line number. In the case where the input source signal is a signal that is based on the PAL standard, the phase of the chrominance sub-carrier wave is shifted by 90 degrees on a scan line basis; therefore, the predetermined line number is determined at “2.”

The ROM of the display control device 4 stores table data of the kind of the source signal input to the display control device 4, a delay line number set for the kind of the source signal, and information as to which of the delay processing portions 424 to use for the delay. From the table data, data indicative of a line number that corresponds to the kind of the source signal is output to the delay processing portions 424, and the data-receiving delay processing portions 424 delay the output of the input video signal for a constant period of time by the line number specified by the data (i.e., the above-described predetermined line number), thus delaying the scan line of the video signal scanned at the display portion 11.

Since the phase of the chrominance sub-carrier wave is shifted by 180 degrees on a horizontal scan period basis in the NTSC standard and the phase of the chrominance sub-carrier wave is shifted by 90 degrees on a horizontal scan period basis in the PAL standard, the above-described configuration makes the line number, which is determined on the basis of the phase, which is controlled on a scan line basis, of the chrominance sub-carrier wave constituting the source signal, such a line number that chrominance sub-carrier waves on adjacent scan lines have mutually reverse phases. Thus, the leak chrominance sub-carrier wave in the luminance signal averages out between adjacent lines during separation into the luminance signal and the chrominance signal and becomes less recognizable, thereby preventing degradation of image quality.

Note that it is only when the source signals for the videos displayed in the viewing directions are the same that the delay processing portions 424 delay the scan line of one video signal by a predetermined line number relative to the scan line of the other video signal. In other words, when the source signal for the video displayed in one of the viewing directions and the source signal for the video displayed in the other viewing direction are from different sources (e.g., when one of the sources is a navigation device and the other source is a DVD player), then the delay processing portions 424 output both the source signal through the decoding portion 422a and the source signal through the decoding portion 422b directly to the synthesis editing portion 425, instead of outputting the source signals through the delaying elements 55.

In order that one of the video signals based on the dual source signals drives a pixel group corresponding to one of the directions while the other video signal drives a pixel group corresponding to the other direction, the synthesis editing portion 425 carries out editing processing of the pixel data arrangement of both video signals while carrying out decimation or filtering as necessary. Such synthesis editing enables a viewer of the display device 1 from one of the directions to see a video corresponding to one of the video signals and another viewer from the other direction to see a video corresponding to the other video signal.

The signals that the delay processing portions 424 output to the synthesis editing portion 425 form any of the following combinations: the signal output from the RGB signal generating portion 423a through the delaying element 55a and the signal output from RGB signal generating portion 423b without mediation of the delaying element 55b; the signal output from the RGB signal generating portion 423a without mediation of the delaying element 55a and the signal output from RGB signal generating portion 423b through the delaying element 55b; and the signal output from the RGB signal generating portion 423a without mediation of the delaying element 55a and the signal output from RGB signal generating portion 423b without mediation of the delaying element 55b.

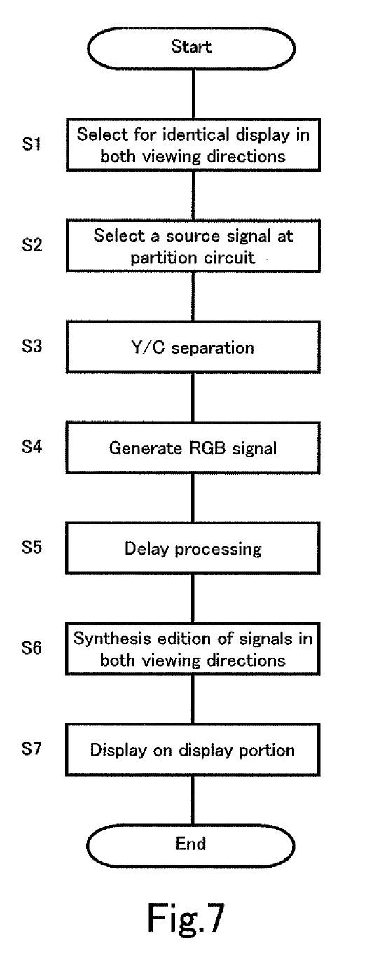

The following describes, by referring to the flowchart shown in FIG. 7, the display device 1 acting as a dual view display in the case of displaying the same videos on the common screen of the display portion 11 in different viewing directions on the basis of source signals of the NTSC standard input to the display control device 4.

When an operator operates operation keys on the display device 1 to select the mode in which the same videos are displayed in both viewing directions of the dual view display and then select a source (the radio wave receiving device 2 acting as the source in this example) for the display (S1), then the source signal selecting portion 421 selects a source signal (S2). Note that the source signal is a composite video signal received at the radio wave receiving device 2.

Since in this example the mode in which the same videos are displayed in both viewing directions of the dual view display is selected, the same source signals are input to the decoding portions 422a and 422b. The decoding portions 422a and 422b separate the respective source signals into a luminance signal Y and a chrominance signal C (S3).

Next the RGB signal generating portions 423a and 423b generate RGB signals as video signals on the basis of the luminance signals Y and chrominance signals C (54).

Upon input of the RGB signals (video signals) generated at the RGB signal generating portions 423a and 423b to the delay processing portions 424a and 424b, the delay processing portions 424a and 424b carry out delay processing detailed below (S5).

The delay processing portions 424a and 424b refers to the table data stored in the ROM of the display control device 4 to determine the line number to delay and which of the delay processing portions 424 to use for the delay. In this example, the delay processing portion 424b is delayed relative to the delay processing portion 424a by 1 line; that is, the signal passing through the delay processing portion 424b is transmitted to the synthesis editing portion 425 through the delaying element 55b, while the signal passing through the delay processing portion 424a is transmitted to the synthesis editing portion 425 without mediation of the delaying element 55a.

The synthesis editing portion 425 synthesizes video signals that are based on the dual source signals, that is, synthesizes a video signal through the delay processing portion 424a and a video signal through the delay processing portion 424b, thereby generating a synthesized video signal (S6).

The synthesized video signal thus generated is transmitted to the display portion 11 through the display outputting portion 43 to be displayed (S7).

Another embodiment will be described below. While in the above-described embodiment description is made of the configuration in which the delay processing portions 424 delay a scan line by a line number determined on the basis of the phase, which is controlled on a scan line basis, of the chrominance sub-carrier wave constituting the source signal, such a configuration may be employed that the delay processing portions 424 delay a scan line by a field number determined on the basis of the phase, which is controlled on a scan line basis, of the chrominance sub-carrier wave constituting the source signal.

This will be detailed below. In the case of a source signal received according to the NTSC standard, two fields constituting one frame of video displayed on the display portion 11 have chrominance sub-carrier waves with phases mutually shifted by 180 degrees.

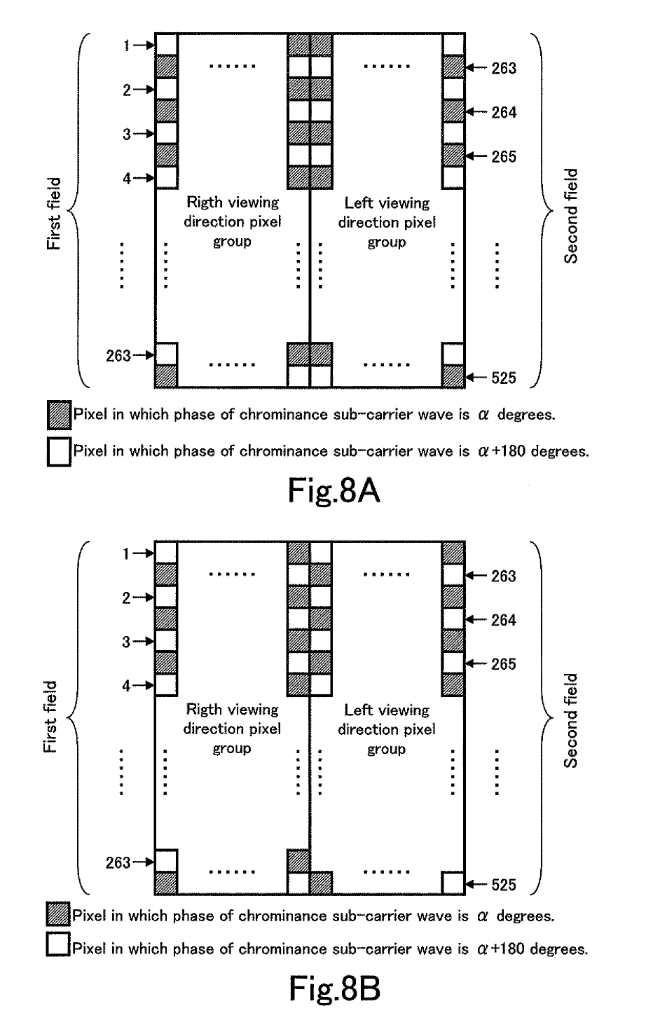

For example, referring to FIG. 8, one frame of video displayed on the display portion 11 and composed of 525 scan lines has a first field of 262.5 lines from “1” to “263” and a second field of 262.5 lines from “263” to “525.” The phases of adjacent lines (e.g., line “2” and line “264”) are mutually shifted by 180 degrees.

In the case where there is no delay of source signal at the delay processing portions 424, horizontally adjacent pixels on the boundary between a right viewing direction pixel group and a left viewing direction pixel group are in a state where the adjacent pixels are similarly emphasized, as shown in FIG. 8A.

In the case where the delay processing portions 424 carry out a one-field delay of the source signal passing through the decoding portion 422b (this source signal being assumed to correspond to the left viewing direction pixel group in FIG. 8) by using mediation of the delaying element 55b, then only the pixels corresponding to the left viewing direction pixel group have the phases reversed in the first field and the second field. That is, without one-field delay, the video displayed on the display portion 11 is in the state shown in FIG. 8A, while with one-field delay, the state turns to the one shown in FIG. 8B.

Thus, with this configuration, the leak chrominance sub-carrier wave in the luminance signal averages out between lines during separation into the luminance signal and the chrominance signal and becomes less recognizable, thereby preventing degradation of image quality.

While the above description is drawn to a one-field delay configuration in the case of a source signal received according to the NTSC standard, the field number for the delay is not limited to one field; a different field number may be employed for the delay depending on the receiving standard.

Alternatively, the delay processing portions 424 may be configured to delay a scan line by a frame number determined on the basis of the phase, which is controlled on a scan line basis, of the chrominance sub-carrier wave constituting the source signal.

This will be detailed below. In the case of a source signal received according to the NTSC standard, there is a 180-degree phase shift in chrominance sub-carrier waves between a field in any frame of the video displayed on the display portion 11 and a field corresponding to the foregoing field in a frame that is displayed following the foregoing frame.

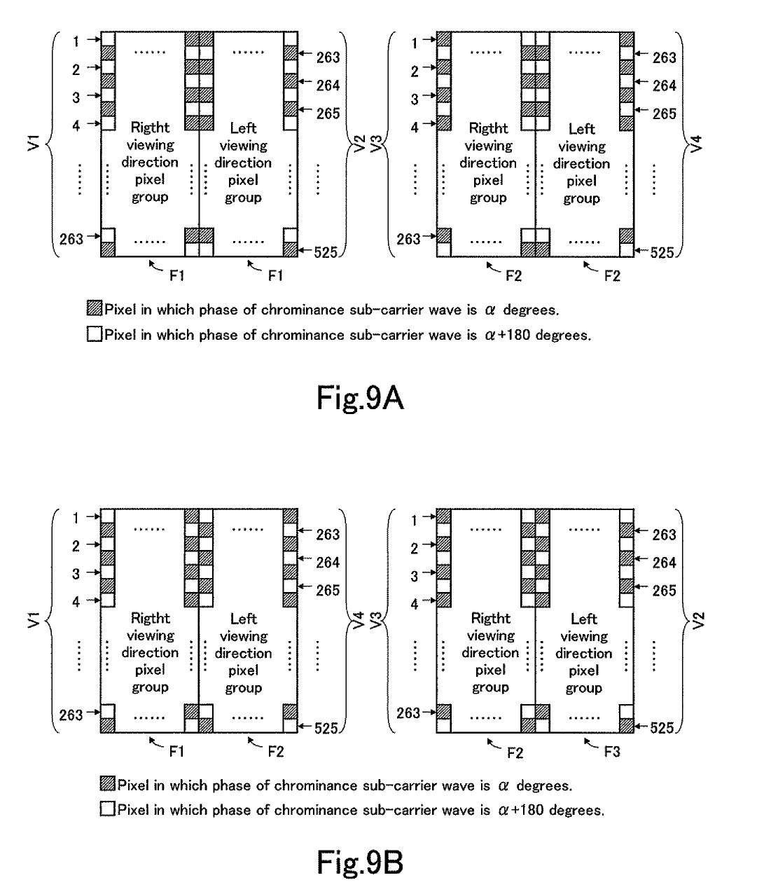

For example, referring to FIG. 9, where a frame “F1,” which is any frame of the video displayed on the display portion 11, is composed of a field “V1” and a field “V2” and a frame “F2,” which is a frame following the frame “F1,” is composed of a field “V3” and a field “V4,” there is a 180-degree phase shift in chrominance sub-carrier waves between the corresponding fields.

That is, the field “V1” of the frame “F1” and the field “V3” of the frame “F2” have the phases of the chrominance sub-carrier waves mutually shifted by 180 degrees, and the field “V2” of the frame “F1” and the field “V4” of the frame “F2” have the phases of the chrominance sub-carrier waves mutually shifted by 180 degrees.

In this regard, in the case where there is no delay of source signal at the delay processing portions 424, horizontally adjacent pixels on the boundary between a right viewing direction pixel group and a left viewing direction pixel group are in a state where the adjacent pixels are mutually emphasized, as shown in FIG. 9A.

In the case where the delay processing portions 424 carry out a one-frame delay of the source signal passing through the decoding portion 422b (this source signal being assumed to correspond to the left viewing direction pixel group in FIG. 8) by using mediation of the delaying element 55b, then only the pixels corresponding to the left viewing direction pixel group have the phases reversed in such a manner that the phase of the chrominance sub-carrier wave in the field “V2” of the frame “F1” becomes the phase of the chrominance sub-carrier wave in the field “V4,” which is the corresponding field, of the next frame “F2,” and the phase of the chrominance sub-carrier wave in the field “V4” of the frame “F2” becomes the phase of the chrominance sub-carrier wave in the corresponding field “V2” of the next frame “F3,” i.e., the corresponding field “V2” of the frame “FL” That is, without one-frame delay, the video displayed on the display portion 11 is in the state shown in FIG. 9A, while with one-frame delay, the state turns to the one shown in FIG. 9B.

Thus, with this configuration, the leak chrominance sub-carrier wave in the luminance signal averages out between lines during separation into the luminance signal and the chrominance signal and becomes less recognizable, thereby preventing degradation of image quality.

While the above description is drawn to one-frame delay configuration in the case of a source signal received according to the NTSC standard, the frame number for the delay is not limited to one frame; a different frame number may be employed for the delay depending on the receiving standard.

While in the above embodiments description is made of the display device 1 acting as an on-board multi-view display, which enables different videos to be simultaneously seen from the driver's seat and the passenger seat, display devices encompassed by the present invention will not be limited to on-board display devices. The present invention also encompasses display devices that enable different videos to be simultaneously seen in more than two viewing directions.

The display device 1 acting as a multi-view display, which is capable of displaying different videos or the same videos on the common screen in different viewing directions, will not be limited to the configurations shown in FIGS. 4, 5, and the like but may also be applied to display devices employing the configuration described in Japanese Unexamined Patent Publication No. 2003-15535 and to multi-view display devices in general configured with organic EL, plasma display, CRT, SED, and the like.

The above embodiments have been provided only by way of description of the present invention, and modifications of the design of the specific circuit configurations of the portions may be made conveniently depending on the established system insofar as the advantageous effects of the present invention will be secured.

1. A display control device comprising a video signal generating portion for generating video signals corresponding to different viewing directions from a plurality of source signals, the display control device outputting the video signals to a display portion capable of displaying different videos on a common screen in the different viewing directions,
wherein the video signal generating portion includes a delay processing portion for, when the source signals for the videos displayed in the different viewing directions are the same, delaying a scan line of one video signal by a predetermined line number relative to a scan line of another video signal.

2. The display control device according to claim 1, wherein the delay processing portion delays the scan line by a line number, a field number, or a frame number determined on the basis of a phase of a chrominance sub-carrier wave constituting the source signal, the phase being controlled on a scan line basis.

3. A display device comprising the display control device of claim 1 and a display portion capable of displaying different videos on a common screen in different viewing directions on the basis of video signals output from the display control device.

4. A display device comprising the display control device of claim 2 and a display portion capable of displaying different videos on a common screen in different viewing directions on the basis of video signals output from the display control device.
